(19) United States
(12) Patent Application Publication
(10) Pub. No.: US 2020/0104111 A1
(43) Pub. Date: Apr. 2, 2020

(54) AUTOMATED UPGRADES OF AUTOMATION ENGINE SYSTEM COMPONENTS

(71) Applicant: CA Software Österreich GmbH, Wien (AT)

(72) Inventors: Andreas Ronge, Reichersdorf (AT); Johann Niederer, Frankenfels (AT)

(73) Assignee: CA Software Österreich GmbH, Wien (AT)

(21) Appl. No.: 16/166,064

(22) Filed: Oct. 19, 2018

Related U.S. Application Data
(60) Provisional application No. 62/739,188, filed on Sep. 29, 2018.

(51) Int. Cl. G06F 8/65; H04L 12/24; H04L 29/08

(52) U.S. Cl. CPC G06F 8/65; H04L 67/34; H04L 41/046

(57) ABSTRACT

A request to upgrade one or more agents hosted on a particular computing system is received and an upgrade package is identified that includes a set of upgrade files. The upgrade package is determined to include a manager upgrade file for a service manager hosted on the particular computing system, where the one or more agents are child processes of the service manager. The agent upgrade files are accessed from the upgrade package and upgrades of the agents are performed using the agent upgrade files. An upgrade of the service manager is also performed using the manager upgrade file based on the request to upgrade, where the upgrade of the service manager is performed with the upgrades of the one or more agents.

### RELATED APPLICATION

This application claims benefit to U.S. Provisional Patent Application Ser. No. 62/739,188, filed Sep. 29, 2018 and incorporated by reference herein in its entirety.

### BACKGROUND

The present disclosure relates in general to the field of computing systems, and more specifically, to automation of software tools in computing systems.

Modern software systems often include multiple programs or applications working together to accomplish a task or deliver a result. An enterprise can maintain several such systems. Further, development times for new software releases are shrinking allowing releases to be deployed to update or supplement a system on an ever-increasing basis. Some enterprises release, patch, or otherwise modify their software code dozens of times per week. Further, enterprises can maintain multiple servers to host their software applications, such as multiple web servers deployed to host a particular web application. As updates to software and new software are released, deployment of the software can involve coordinating the deployment across multiple machines in potentially multiple geographical locations.

### BRIEF SUMMARY

According to one aspect of the present disclosure, a request to upgrade one or more agents hosted on a particular computing system may be received and an upgrade package may be identified that includes a set of upgrade files. The upgrade package may be determined to include a manager upgrade file for a service manager hosted on the particular computing system, where the one or more agents are child processes of the service manager. The agent upgrade files may be accessed from the upgrade package and upgrades of the agents are performed using the agent upgrade files. An upgrade of the service manager may also be performed using the manager upgrade file based on the request to upgrade, where the upgrade of the service manager is performed with the upgrades of the one or more agents.

### BRIEF DESCRIPTION OF THE DRAWINGS

FIG. 1 is a simplified schematic diagram of an example computing system including an example deployment automation system in accordance with at least one embodiment;

FIG. 2 is a simplified block diagram of an example computing system including an example deployment automation engine in accordance with at least one embodiment;

FIG. 3 is a simplified block diagram illustrating an example system including multiple deployment nodes in accordance with at least one embodiment;

FIG. 4 is a simplified block diagram illustrating an example automation engine system in accordance with at least one embodiment;

FIG. 5 is a simplified block diagram illustrating an example of a centralized upgrade of agents in an example automation engine system in accordance with at least one embodiment;

FIGS. 6A-6D are simplified block diagrams illustrating an example upgrade of an automation engine in accordance with at least one embodiment;

FIG. 7 is a simplified flow diagram illustrating an example technique for upgrading agents and a service manager within an example automation engine system in accordance with at least one embodiment.

Like reference numbers and designations in the various drawings indicate like elements.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely in hardware, entirely software (including firmware, resident software, micro-code, etc.) or combining software and hardware implementations that may all generally be referred to herein as a “circuit,” “ module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

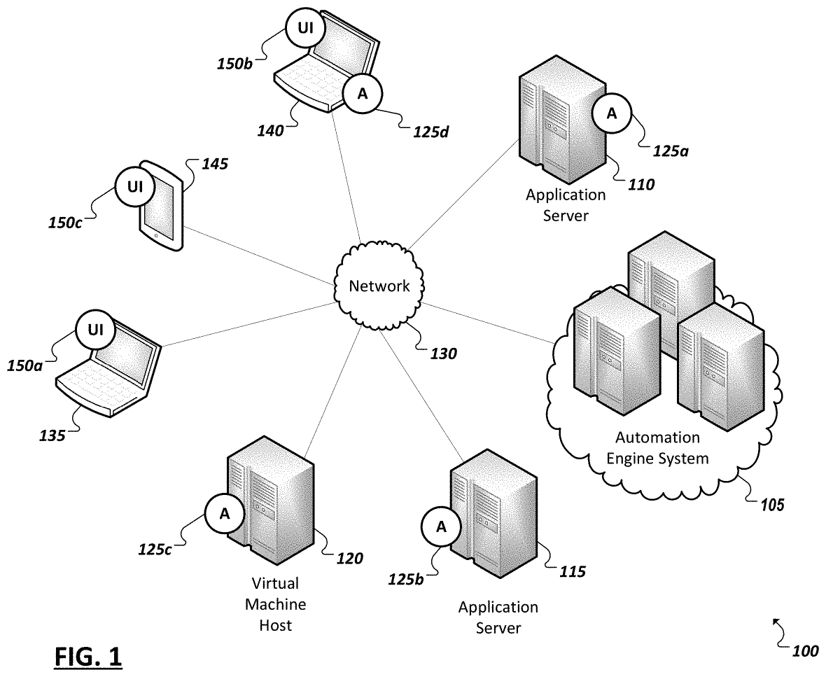

Referring now to FIG. 1, a simplified block diagram is shown illustrating an example computing environment 100 including an example automation engine system 105. The automation engine system 105 may be implemented on one or multiple host server devices and may flexibly implement a variety of software automation solutions and applications including release automation, workload automation, and automated service orchestration. An automation engine system may implement an automation engine implemented through a collection of interconnected work processes (hosted on one or more of the servers of the automation engine system 105) and communication processes (hosted on one or more the servers of the automation engine system 105). The work processes may be configurable to perform tasks to automate a variety of tasks on a computing system local to or remote from the automation engine system 105. For instance, an automation engine hosted on automation engine system 105 may automate workflows utilizing software applications, scripts, applets, or other software programs hosted on one or multiple different target computing systems, such as application server systems (e.g., 110, 115). In other instances, the automation engine may be utilized to orchestrate a service or automate the deployment and installation of a new software release on one or more of these systems (e.g., 110, 115) or other computing systems (e.g., a virtual machine or container-based host system (e.g., 120)), among other examples. Hosts and server systems may also be implemented on personal computing devices (e.g., 140), Internet of Things (IoT) devices, smart home systems, media consoles, smart appliances, and other computing systems, which may interface with an automation engine (on automation engine system 105) over one or more networks (e.g., 130) in connection with workflow automation, release automation, service orchestration, or other software automation applications supported by the automation engine.

In some implementations, agents (e.g., 125a-d) may be provisioned on host systems (e.g., 110, 115, 120, 140) to provide a hook for the automation engine to control operating system tasks or other operations and functionality provided on a host system through an operating system, hypervisor, application, or other software program, which may facilitate a workflow automation, release automation, service orchestration, or other software automation implementation. An automation engine may communicate with various agents deployed within host systems (e.g., 110, 115, 120, 140), for instance, through communication processes implementing the automation engine. In some implementations, communication processes may support and implement network communications (e.g., over one or more networks (e.g., 130)) between the computing system(s) (e.g., 105) hosting the work processes and other components of the automation engine. Further, in some implementations, user interfaces (e.g., 150a-c) may be defined in connection with the automation engine, which may be accessed on one or more user computing devices (e.g., 135, 140, 145), for instance, as a web-based or browser-implemented user interface. Users may provide inputs and define parameters for an automation implemented by the automation engine through these UIs (e.g., 150a-c). The inputs may be routed to one or more of the work processes of the automation engine using the communication processes of the automation engine, to allow for the definition of user-customized automations and even the definition of new or customized automations provided through the automation engine, among other examples.

In general, “servers,” “clients,” “computing devices,” “network elements,” “database systems,” “user devices,” and “systems,” etc. (e.g., 105, 110, 115, 120, 135, 140, 145, etc.) in example computing environment 100, can include electronic computing devices operable to receive, transmit, process, store, or manage data and information associated with the computing environment 100. As used in this document, the term “computer,” “processor,” “processor device,” or “processing device” is intended to encompass any suitable processing apparatus. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, zOS, etc., as well as virtual machines and emulators adapted to virtualize execution of a particular operating system, as well as container-based operating environments (e.g., Docker containers, Kubernetes containers, etc.), and customized and proprietary operating systems among other examples.

Further, servers, clients, network elements, systems, and computing devices (e.g., 105, 110, 115, 120, 135, 140, 145, etc.) can each include one or more processors, computer-readable memory, and one or more interfaces, among other features and hardware. Servers can include any suitable software component or module, or computing device(s) capable of hosting and/or serving software applications and services, including distributed, enterprise, or cloud-based software applications, data, and services. For instance, in some implementations, an automation engine system 105, application server (e.g., 110, 115), host server 120, or other sub-system of computing environment 100 can be at least partially (or wholly) cloud-implemented, web-based, or distributed to remotely host, serve, or otherwise manage data, software services and applications interfacing, coordinating with, dependent on, or used by other services and devices in environment 100. In some instances, a server, system, subsystem, or computing device can be implemented as some combination of devices that can be hosted on a common computing system, server, server pool, or cloud computing environment and share computing resources, including shared memory, processors, and interfaces.

While FIG. 1 is described as containing or being associated with a plurality of elements, not all elements illustrated within computing environment 100 of FIG. 1 may be utilized in each alternative implementation of the present disclosure. Additionally, one or more of the elements described in connection with the examples of FIG. 1 may be located external to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

Through the advent of cloud and distributed computing architectures, together with agile software development paradigms, the management and implementation of software systems by enterprises has become increasingly complex. For instance, as computing systems migrate to cloud or hybrid cloud environments, managing workflows and deployment of new software may be more complex and costly without information technology automation. Further, given the rapid pace of software innovation, versioning, and updates, the pace at which software is released and orchestrated has likewise increased. For instance, in the case of release automation, releases and updates may be frequent, complex, and expensive to deploy in modern software systems. Managing the potentially thousands of software releases, even relating to a single entity's (e.g., enterprise's) system, can be difficult and exact costs on the very operability of the system. Such releases include both releases of new software systems as well as updates or patches to existing software. Valuable information technology (IT) personnel and resources are dedicated within some enterprises to developing and carrying-out these deployments. Traditionally, human users are employed throughout the process of the deployment. Further, human IT resources are not only expensive, but error prone, resulting in some deployments which are incorrect and that may need to be re-deployed, further consuming time and personnel resources. Additionally, some systems may be sensitive to down periods that may be required in order to allow deployment of new software releases on the system, among other complexities, costs, and variables. Similar complexities and costs are introduced when considering the orchestration of new services, managing workflows in transactions to be handled and developed using a software system, among other example considerations.

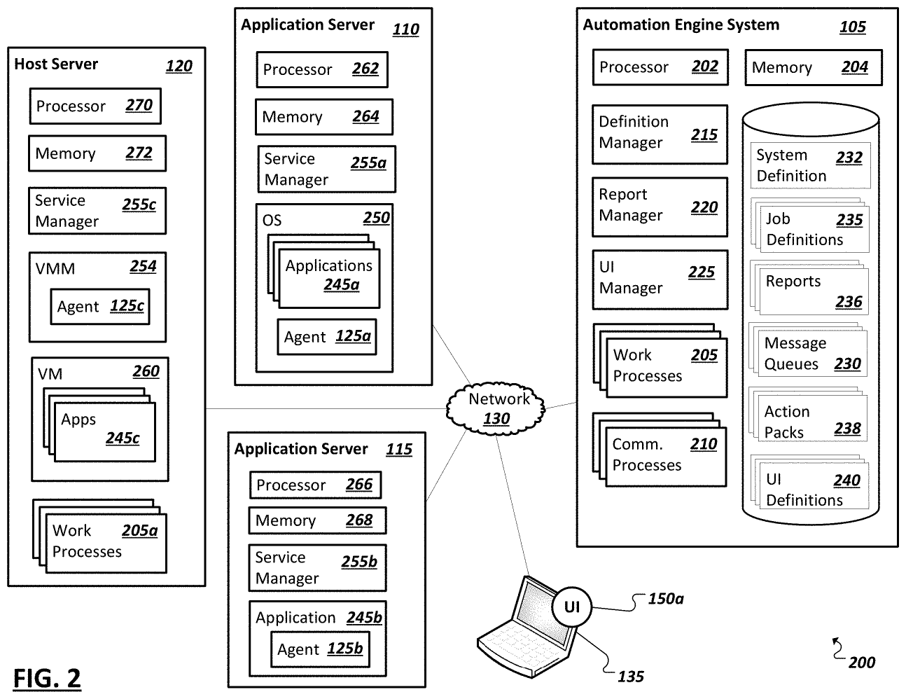

Automation tools and processes may be purpose built to handle common automation tasks, however, given the diversity and continuing evolution of enterprises' software systems, specialized, purpose-built automation tools are often ill-equipped to adapt to the ever-changing landscape of modern software products and systems. In some implementations, a flexible, scalable, and configurable automation engine may be provided, which is capable of being used, reused, and repurposed, dynamically, to provide a single automation platform capable of handling and be extended to handle a wide and diverse array of automation workloads and tasks. At least some of the systems described in the present disclosure, such as the systems of FIGS. 1 and 2, can include functionality providing at least some of the above-described features that, in some cases, at least partially address at least some of the above-discussed issues, as well as others not explicitly described.

For instance, in the example of FIG. 2, a simplified block diagram 200 is shown illustrating an example environment including an example implementation of an automation engine system 105. An automation engine implemented using the automation engine system 105 may be composed of a collection of work processes 205 and communication processes 210. Work processes (e.g., 205) are server processes implemented within the automation engine to perform the actual server work in various automations, such as activating, generating, and executing tasks within a given automation job, together with monitoring the status of the tasks and collecting information (and generating report data) relating to the completion of these tasks. Work processes 205 may retrieve tasks from a queue, with the tasks including logic executable by the work process to cause the work process to perform a particular type of task. When the work process 205 accesses a next task from the queue, it may retrieve corresponding logic and perform the next task, which may be the same or a different type of task than the work process's previously performed task. Indeed, the flexibility of the work processes allow a configurable mix of tasks and corresponding jobs to be handled by the collection of the work processes 205 in the automation engine, allowing the automation engine to respond dynamically to what may be a changing and diverse workload the automation engine is called on to handle. In other instances, work processes may be configured to be dedicated to handling particular types of high priority or low latency tasks, such that all of the work process's bandwidth is directed toward these types of tasks in the automation engine's workload (e.g., despite the work process being otherwise operable to handle potentially any one of the variety of tasks in jobs handled by the automation engine).

Further, one of the work processes implemented in the automation engine may be designated as the “primary” work process. A primary work process, in some examples, may be designated at the launch of the automation engine (e.g., based on the work process being the first to start) and this primary work process may be assigned special tasks based on its designation as the primary process, such as central work process tasks. In some cases, the primary work process may be tasked with autonomously assigning roles to additional work processes as they are started within the automation engine. In some implementations, work processes may be assigned roles to filter the types of tasks the respective work process is to handle. For instance, some work processes may be assigned (e.g., by the primary work process) to perform an output server role to handle outputs such as storing log messages and reports generated in the automation engine within a database of the automation engine. Another example server role which may be assigned to work processes may be a resource calculation role to perform tasks such as calculating calendar objects, perform deadlock avoidance, and other tasks, which involve calculations, among other examples. In some implementations, separate queues may be maintained in the automation engine database for each server role, such that tasks of a given work process are extracted from the specific queue corresponding to the work process's assigned role, among other example features and implementations.

Communication processes (e.g., 210) are additional server processes running on one or more computing systems (e.g., 105) implementing an instance of an automation engine. Communication processes 210 may handle communication between agents (e.g., 125a-c)), user interfaces (e.g., 150a), and work processes (e.g., 205) in connection with the automation engine. Communication processes hold the connections to the agents and the user interfaces. In some implementations, all communication between agents and UIs may be exclusively performed through the communication processes 210. In some implementations, port numbers of the systems hosting the automation engine may be assigned to respective work processes and communication processes. All of the server processes (e.g., work processes 205 and communication processes 210) may communicate with each other. Such an architecture can ensure flexibility and fault tolerance, allowing remaining processes to assume the queued tasks of another process in the event the other process fails, among other example features and advantages.

As noted above, a communication process can connect with agents (e.g., 125a-c) and UIs (e.g., 150a) to facilitate the communication between the agents and UIs and various work processes (e.g., 205) of an automation engine implementation. Agents may be implemented on target systems (e.g., 110, 115, 120) to expose functionality of an operating system (e.g., 250), application (e.g., 245b), virtual machine manager (e.g., 254), or other software program to the automation engine. Accordingly, agents may be implemented according to the specific features of the target software component (e.g., 245b, 250, 254, etc.). As an example, different agents may be provided for instrumentation on any one of a variety of different operating systems, such as agents specific to Windows, Linux, iOS, zOS, etc., among other examples. In some implementations, agents may initiate connections with one of the communication processes provided in an automation engine. For instance, an agent may open a TCP/IP connection with one of the communication processes of the automation engine. In some implementations, each agent may connect to a single one of the communication processes, while each communication process may be connected to multiple agents and/or user interfaces. Communications between the agent and a communication process may be encrypted.

As discussed in the examples above, a collection of work and communication processes may be provided in an automation engine system. In some cases, it may be advantageous to host the work processes 205 and communication processes 210 on multiple nodes or computing devices, as this can enhance fault tolerance of the automation engine and boost efficiency and reliability through the distribution of these processes over several computers. In some implementations, a potentially unlimited number and variety of work and communication processes may be implemented in a single automation engine instance. Further, by adding processes it is possible to adjust to growing use of the automation engine system. For instance, should a heavy workload exist or be introduced due to the number of logged-on agents and/or UIs, the number of communication processes can be increased. Likewise, should the number of automation engine system tasks become too burdensome, the number of work processes can be increased, among other example advantages.

As further illustrated in FIG. 2, an example automation engine system 105 may include one or more data processing apparatus (e.g., 202), one or more computer memory elements 204, and other components and logic, implemented in hardware circuitry and/or software to implement an automation engine instance. For instance, a definition manager 215 may be provided, through which a system definition file 232 may be accessed, modified, and/or defined. A system definition 232 may define the number of work processes 205 and communication processes 210 within an automation engine instance, as well as detail the individual computing systems hosting these server processes, the ports assigned to each process, among other information utilized to define an automation engine instance. A definition manager 215 may additionally access and/or define job definitions, which may correspond to automation jobs that may be performed by the automation engine. The job definitions 235 may additionally detail the combination of automation tasks and the target systems involved in the performance of these tasks in the furtherance of such automation jobs. Automation jobs may provide the information to be loaded into work queues consumed by work processes 205 in the automation engine. In some cases, automation jobs may be packaged in action packs (e.g., 238), which may be pre-generated packages of common types of automations, which may be reused and redeployed in various customers' respective automation engine instances. An individual instance of an automation engine may allow a user or manager to parameterize the action pack to enable the action pack's use within a particular customer's system (with its component target systems) (e.g., using definition manager 215). In some implementations, a report manager 220 may also be provided, which may enable user access to reports 236 and other data generated through the execution of various automation jobs by the automation engine (e.g., as generated by work processes 205 within the automation engine). A UI manager 225 may also be provided, in some implementations, to allow users or managers to define new UIs or parameterize UI templates for use in providing UIs (e.g., 150a) that are to interface with and be used in connection with automation jobs performed by an automation engine deployment. UI definitions 240 may be generated and maintained by the automation engine system 105 to form the basis of these UIs (e.g., which may be presented through web- or browser-based interfaces on potentially any user endpoint device (e.g., 135) capable of connecting to the automation engine over a private or public network (e.g., 130)).

In some implementations, communication between server processes of an automation engine (e.g., its component work processes 205 and communication processes 210)) may be facilitated through message queues 230. Message queues (as well as other data used to implement an automation engine instance (e.g., 232, 235, 236, 240, etc.)) may be hosted in a database implemented in connection with the automation engine and hosted on one of the computing systems of automation engine system 105. Message queues (e.g., 230) may be implemented as database tables, through which a work or communication process may post a message that may then be read and processed by another work or communication process, thereby facilitating communication between the processes. Additional queues may also be provided which contain the tasks that are to be accessed by server processes and performed in connection with an automation engine implementation. In some implementations, an automation engine instance may have multiple message queues. Depending on their types, tasks are lined up in the corresponding queue. If a work process is momentarily idle or finished with its current tasks, it will take the next queued task and process it. The execution of the task can lead to a new task for the work queue to be then attached to the current tasks. Some tasks may be dedicated tasks, which are allowed to only be processed by the primary work process. Accordingly, in such implementations, a primary work process, upon completing a preceding task, may first check (in a corresponding queue) whether any special work tasks are waiting in the queue before turning to more general work queues for generally work tasks shared with the other work processes. or this reason, the “freed-up” primary work process always checks first if any of these special work processes are present in the queue. Communication processes may utilize communication queues for communication tasks to be performed by communication processes to collect or send data from/to agents and/or UIs associated with the automation engine. In some instances, if a work process tasks involves the passing of information to agents or UIs, the work process may, as part of the performance of its task, write a new communication queue to the respective communication queue in order to prompt the communication process's involvement in the passing of this information, among other examples.

As noted above, an automation engine provided through an automation engine system 105 may be used to automate activities on various target systems (e.g., 110, 115, 120). For instance, application servers (e.g., 110, 115) hosting various applications and other software tools and programs (e.g., 245a-b) may be target systems of an automation engine. For instance, tasks automated by an automation engine may automate deployment of a new or updated version of an application or system of interoperating programs on one or more computing systems (e.g., 110, 115, 120). In other examples, a workflow involving one or more multiple different cooperating applications (e.g., 245a-c) may be automated may be automated using an automation engine, among other examples. The automation engine may interface with agents to cause functionality present on the target system to be triggered and automated according to defined automation engine tasks and jobs. In some instances, agents (e.g., 125a) may be present on an operating system (e.g., 250) of the host system (e.g., 110), on which a target application (e.g., 245a) runs. In other instances, the agent (e.g., 125b) may be present on the application (e.g., 245b) itself. During the automation of a workflow, the automation engine may communicate with and cause actions to be performed on multiple different applications (e.g., 245a-c) and host systems (e.g., 110, 115, 120) through corresponding agents (e.g., 125a-c). In automation jobs involving service orchestration or release automation, agents (e.g., 125a, c) may be used to access functionality and resources of the system that are used to deploy, install, configure, load, or otherwise automate deployment or installation of a program on one or more target systems. As an example, an application may be automatically deployed on a virtual machine using an example automation engine, through the automation engine's communication with an agent (e.g., 125c) provided on a virtual machine manager (VMM) or hypervisor (e.g., 254) that is to automatically build the host virtual machine (e.g., 260) upon which the application (e.g., 245c) is to be installed and run at the direction of the automation engine, among other examples.

In some implementations, a service manager process (e.g., 255a-c) may be present on any host system (e.g., 110, 115, 120, etc.) that is to host one or more agents (e.g., 125a-c) that are to interface and interoperate with (and at the direction) of an automation engine instance. In some implementations, a service manager (e.g., 255a-c) may manage and govern the activation and deactivation of agents (e.g., 125a-c) on the host (e.g., 110, 115, 120). Further, in cases where one or more processes (e.g., communication processes, work processes, etc.) implementing the automation engine are hosted in a distributed manner on various machines (e.g., 120), a service manager (e.g., 255c) may likewise manage and serve as the parent process of these processes (e.g., work processes 205b). As shown in the example of FIG. 2, a host system (e.g., 120) may not only host one or more agents (e.g., 125c), but may also host one or more automation engine processes (e.g., 205b), with the service manager (e.g., 255c) on the host (e.g., 120) serving as the parent process and centralized manager for all of these processes. The service manager (e.g., 255a-c) may be automatically launched in connection with the activation or reboot of a given host system (e.g., 110, 115, 120), such as on or shortly after the host system reboots. Other automation engine components (e.g., 125a-c, 205b, etc.), however, may depend on the service manager (e.g., 255a-c) for activation. The service manager may control how, when, and in what order various automation engine components are launched. The service manager may also orchestrate and manage the upgrade and installation of new agents and automation engine processes on its host, among other example functionality. The service manager may launch with elevated privileges, enabling the service manager to start sub-processed in accordance with these privileges (e.g., even if the human user does not otherwise possess such access rights), among other example features.

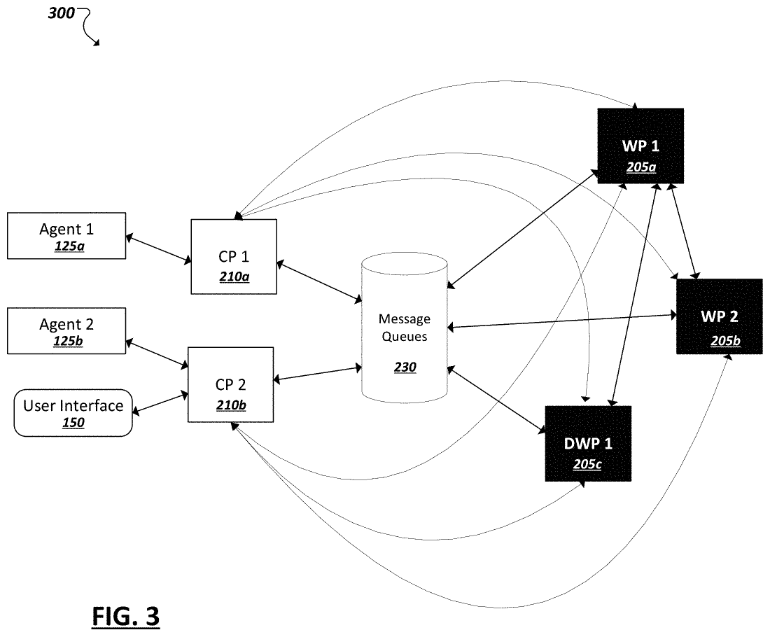

Turning to FIG. 3, a simplified block diagram 300 is shown illustrating an example automation engine implementation. In this simplified example, the automation engine may be implemented through work processes 205a-c, communication processes 210a-b, and a database hosting automation engine information including tables implementing message queues (e.g., 230) of the automation engine. In this example, work process 205a may be designated as the primary work process and may connect with and oversee the launch of the other work processes (e.g., 205b-c) in the automation engine. One or more of the work processes (e.g., 205c) may be a dedicated work process, dedicated to performing a particular type of task (e.g., a dialogue work process (DWP) specifically for use in handling UI messages (e.g., from UI 150)), while other work processes (e.g., 205b) are general purpose work processes, which may be utilized to handle potentially any type of work task to be performed in the automation engine. Each work process (e.g., 205a-c) may interface with one or more message queue tables to obtain new tasks for execution and/or communicate messages with other work processes or communication processes in the automation engine. Likewise, communication processes (e.g., 210a-b) may interface with message queues 230. Some message queues may be dedicated message queues, reserved for a particular subset of the server processes (e.g., 205a-c, 210a-b) in the automation engine, while other queues may be provided for access and use by potentially any one of the automation engine server processes. Each communication process (e.g., 210a-b) may be connected to one or more agents (e.g., 125a-b) and/or one or more UIs (e.g., 150) provided for interfacing with the automation engine. Agents (e.g., 125a-b) may expose functionality of a target system for use by the automation engine. UIs may be provided to enable users to submit information for use by the automation engine and/or to present information (e.g., prompts, results, status updates, etc.) generated by the automation engine to the user, among other examples.

It should be appreciated that an automation engine may include any potential number of one or more work processes and communication processes. As the workload to be handled by the automation engine or the general complexity of the automation engine implementation increases, additional work and/or communication processes and corresponding message queue tables may be added to expand the bandwidth and flexibility of the automation engine. Likewise, the scale and scope of an automation engine may also be reduced, by removing work and/or communication processes, among other examples. As an illustrative example of a job, which may be performed by an example automation engine, a workflow involving an example customer relationship management (CRM) platform may be automated using an example automation engine, such as shown in the example of FIG. 3. Jobs may be defined, which are designed to automate the generation of social media promotions (e.g., handled by a first target system) based on events detected using a second target system (e.g., a system that can forecast or detect weather patterns and/or predict foot traffic within a retail establishment, etc.).

In one example, when certain weather conditions are detected or predicted, an example workflow can cause a social media management system to automatically generate a promotional posting on one or more social media platforms to promote an offering appropriate for the detected weather (e.g., an ice cream promotion on a hot day). For instance, a first one of the work processes (e.g., 205b) may perform a task to cause a weather forecast to be performed using a first target system. The performance of this task may involve causing a communication process (e.g., 210a) interfacing with the target system through a corresponding agent (e.g., 125a) to send a communication to the agent to engage with the target system and cause the target system to generate forecast data. This forecast data may be passed back to the automation engine by the agent 125 through the communication process 210a, and the forecast data may be provided to a message queue and cause a task to be performed by one of the work processes to access and process the forecast data returned from the target system. For instance, work process 205a may be free to handle the task of processing the forecast data, with the task involving determining a weather event from the forecast data. In one example, a work process 205a may determine that the forecast data evidences a warm weather event. The detection of a warm weather event may cause a task to be queued to trigger the social media promotion on a social media system. The workflow definition may embody the logic, executed by the work processes to determine an action, result, or next task to execute based on results of the preceding task. In one example, a free work process may access the queued task and communicate an instruction to launch the social media promotion through a communication process (e.g., 210b) interfacing with the social media system through a corresponding agent (e.g., 125b), among other example implementations and use cases. Indeed, it should be appreciated that potentially any combination of the provided work processes (e.g., 205a-c) in the automation engine may perform various tasks within a single automation job (e.g., a workflow automation job, service orchestration job, release automation job, etc.) based on the availability of the various work processes. Further, an automation engine may simultaneously handle multiple different automation jobs using the same collection of work processes and communication processes 210a-b, balancing work of the multiple jobs between the collection of processes in the automation engine, among other example implementations.

In some implementations, when an agent is launched on a particular target or host system for operation with a particular automation engine, the agent may attempt to identify and connect to the automation engine through one of the communication processes provided in the automation engine. For instance, a service manager utility present on a particular host computer may select a particular agent implementation and designate this agent for use with a particular one of potentially many different automation engines. The agent, too, may be selected from one of potentially many different agent implementations offering various functionality and/or compatibility with various different operating system, software containers, applications, and the like. The service manager may then cause the agent to be loaded and run on the particular host machine. In some implementations, without a connection to a communication process of the selected particular automation engine, the agent is unable to interface and operate with the particular automation engine. A load balancing algorithm may be employed to govern how agents connect to which communication processes within the corresponding automation engine, among other example features.

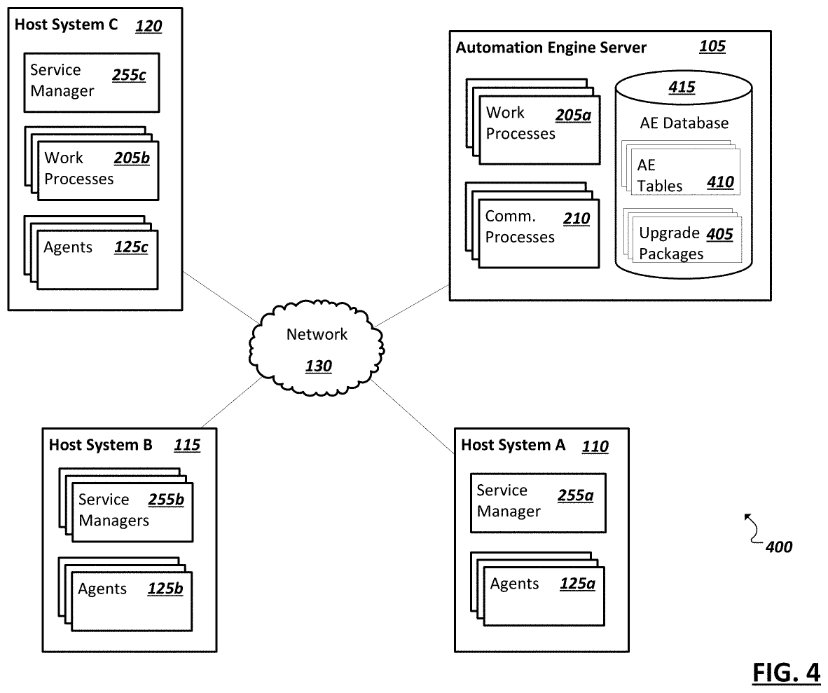

Turning to FIG. 4, a simplified block diagram 400 is shown, illustrating the distribution of various automation engine processes within a computing environment composed of various host computing systems (e.g., 105, 110, 115, 120, etc.). For instance, a first host system 110 may host a first set of agents 125a, a second host 115 may host a second set of agents 125b, and a third host 120 may host a third set of agents 125c as well as one or more work processes 205b, or other processes of an automation engine. A server system 105, in one example, may serve as the core host of the automation engine, hosting several automation engine processes (e.g., 205a, 210) and/or the automation engine database 415. The automation engine database 415 may host the core automation engine table 410, including those implementing the message queues of the automation engine, those storing configurations and workflow definitions for the automation engine, among other critical data relied upon for the proper function of the particular automation engine.

The automation engine database 415 may further include upgrade packages (e.g., 405) for use in upgrading components of the automation engine in a centralized manner. For instance, each upgrade package 405 may include a number of files corresponding to the upgrade of a particular component, or instances of a particular component. For instance, an agent may be developed for use with an automation engine instance and instances of the agent may be developed for each one of multiple different operating systems and environments, which may be used at various host systems. In this manner, an agent enabling certain functionality that may be leveraged by a work process in various workflows of a particular automation engine instance may be potentially launched on any one of the multiple different operating systems to perform corresponding actions utilizing resources and functionality of the corresponding operating system. In some examples an upgrade package may include the upgrade files to enable the updating of any one of the operating-system-specific implementations of the agent. Upgrade packages may also include upgrade files for multiple different types of agents, as well as for the operating-system-specific implementations of each agent type. In this manner, an upgrade to a code or feature present in multiple different agent types may be rolled out through a single package, which may be used to upgrade any one of the agent implementations to include the updated features.

In the example of FIG. 4, one or more of the systems hosting components of an automation engine may host and utilize one or more service managers (e.g., 255a-c) to serve as the parent process of automation engine components (e.g., agents (e.g., 125a-c), work processes (e.g., 205b), communication processes, etc.) hosted on the same physical host system. As a host system (e.g., 115) may potentially participate in or be a target system of multiple different automation engine instances, in some implementations, such host systems (e.g., 115) may include multiple service managers (e.g., 255b), one for each automation engine associated with the host system (e.g., 115). Each service manager (e.g., 255a-c) may act to selectively activate one or more agent instances on the host system. Data may be maintained, which is accessible to the service manager on the host, to identify which agents are assigned or mapped to the service manager as child processes, as the service manager 255a-c may act autonomously (or at the direction of a user or the automation engine) to activate these agents. Once activated, the agents may attempt to connect to the automation engine, by identifying and connecting through one of the communication processes of the automation engine.

An agent, when connected to the automation engine (and thereby the automation engine database 415) may retrieve corresponding files from the database 415 and perform a self-upgrade using the files. Users may provide inputs (e.g., through a service manager on the host) to dictate the version of the agent, which the user or administrator wishes to be utilized (e.g., to rollback to an earlier, more stable version of the agent), among other examples. In some implementations, an agent, upon initiating communication with the automation engine may query upgrade records of the automation engine to detect whether any relevant upgrades are available for the agent (e.g., in a corresponding upgrade package 405). In other cases, the service manager may be used to detect the presence of upgrade packages associated with any of the agents or processes implemented using the service manager. In cases, where multiple agents are present on the same host and an upgrade package includes upgrade files relevant to the multiple agents, the upgrade package may be accessed, such that all of the agents are upgraded concurrently in accordance with the upgrade package.

While upgrade packages (e.g., 405) may be utilized to keep agents up to date and to centrally organize upgrades of agents of a particular automation engine, regardless of where they are hosted (e.g., using automation engine database 415), circumstances may also call for features, functions, and aspects of service managers (e.g., 255a-c) associated with the automation engine to be upgraded from time to time. In one example, upgrade packages may include not only the agent upgrade files but also upgrade files for the upgrade of service managers (e.g., 255a-c) of the automation engine. In some implementations, when an agent at a particular host system attempts to access an upgrade file from an upgrade package, the service manager may monitor the access attempt to determine opportunistically whether the same upgrade package includes upgrade files for the service manager. Should service manager upgrade files be detected in the upgrade package the service manager may automatically extract the files and perform a self-upgrade with the agent(s) on the host system using the service manager upgrade files.

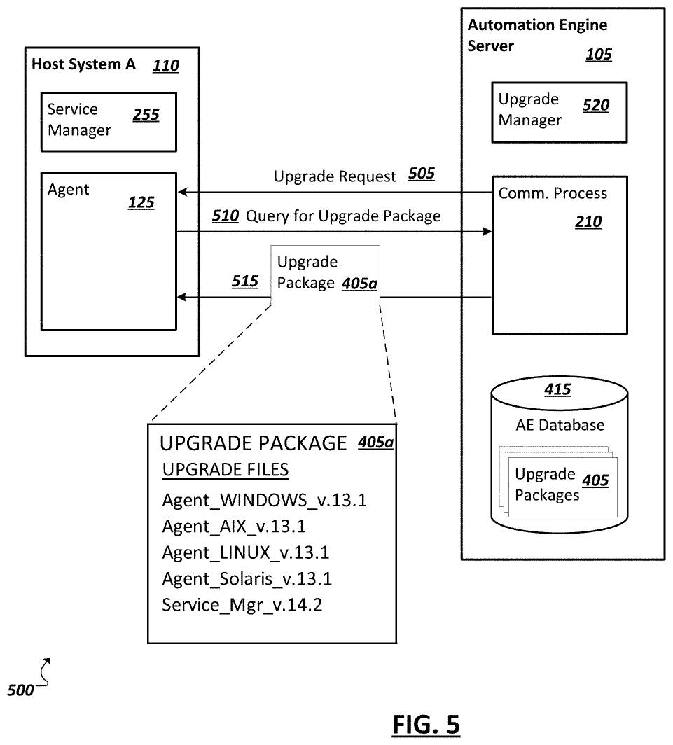

Turning to FIG. 5, a simplified block diagram 500 is shown illustrating an example upgrade of automation engine components on a particular host system (e.g., 110). In this example, the host system may include a set of one or more agents (e.g., 125) on the host 110. The agent 125, in this example, may query the automation engine database 415 of an automation engine through one of the communication processes (e.g., 210) of the automation engine, to detect upgrade packages 405 available for agents of the automation engine. In some implementations, an agent 125 may be automated or manually directed be a user to query the automation engine database 415 to identify whether an upgrade package is available for the agent. In other implementations, the service manager may receive information from the automation engine identifying new upgrade packages that are available. For instance, the service manager may be prompted by the automation engine to automate an attempted upgrade by agents managed by the service manager and/or to cause a notification of the upgrade package to be presented to a user at the corresponding host system 110, among other examples. Such information may prompt an upgrade attempt by corresponding agents (e.g., at the direction of the service manager 255 autonomously or through a user input received through a user interface of the service manager, etc.), among other examples. The agent, upon connecting to the automation engine, may access, from the automation engine, any upgrade packages available for the agent (and, when included, a corresponding service manager).

As shown in the example of FIG. 5, in one example, an automation engine may signal (at 505) to the various systems providing agents to the automation engine that new upgrade packages are available. In some cases, a service manager (e.g., 255) at the receiving host system (e.g., 110) may identify the request 505 and cause agents (e.g., 125) at the host to be activated. In response to an identification 505 of a potential agent upgrade, an agent (e.g., 125) may connect to the server 105 hosting the automation engine database 415 (e.g., through a particular communication process (e.g., 210) of the automation engine) to access the identified upgrade package (e.g., 405a). In connection with the agent 125 accessing (at 510, 515) the upgrade package 405a, the service manager 255 may determine whether the upgrade package (e.g., 405a) includes an upgrade file for the service manager. For instance, the service manager 255 may monitor the operations of its child agents and detect attempts to access upgrade packages (e.g., 405a) and/or requests to update its child agents (e.g., received from a user or from the automation engine), which may cause the service manager 255 to inspect the contents of the upgrade package 405a. In one example implementation, upon completing a self-upgrade based on an upgrade package (e.g., 405a), an agent may automatically shut down with a specific return code. Detection of this shut down event (e.g., through the return code), may trigger the service manager 255 to check the upgrade package used by the agent to perform the upgrade in order to determine whether the package also includes upgrade files for the service manager, among other example implementations. Accordingly, the service manager 255 may parse the names or file types of the individual upgrade files contained in the upgrade package 405a to determine whether any of the included upgrade files is an upgrade file for the service manager 255.

In the particular example of FIG. 5, the upgrade package 405 includes various agent upgrade files (e.g., Agent_WINDOWS_v.13.1; Agent_AIX_V13.1; etc.) as well as a service manager upgrade file (e.g., Service_Mgr_v.14.2). The agents that are to be upgrade (e.g., the agents for which a corresponding upgrade file is found in the upgrade package), may extract the agent upgrade file and use the file to perform a self-upgrade. Likewise, where the service manager (e.g., 255) detects the presence of a corresponding service manager upgrade file, the service manager 255 may, autonomously and unprompted by a user, use the upgrade file to perform a self-upgrade of the service manager with the upgrade(s) of the agent(s) (e.g., 125) that were requested (e.g., by the automation engine or a user/administrator).

In some implementations, an automation engine system may include an upgrade manager utility or tool (e.g., 520), which may be executable to load and define new upgrade packages on the automation engine database 415. Upgrades may be provided, in some implementations, by a vendor associated with the automation engine, or may be custom developed by the enterprise on whose system the automation engine is to run, among other examples. The upgrade manager 520 may be utilized to cause upgrades of selected sets or subsets of agents within the automation engine system to be requested and triggered (e.g., such as discussed in the example of FIG. 5). For instance, some collections of agents may be selected to be upgraded (or even downgraded) to one agent version (e.g., using a corresponding upgrade package 405), while other agents in the system are selected to remain or be up/downgraded to another, different version (e.g., corresponding to an original version or using a corresponding upgrade package 405), among other examples. The upgrade manager 520 may provide a user interface, enabling users to define which collections of agents are to be upgraded or maintained at their current versions. The upgrade manager may then initiate centrally, for the entire automation engine system, upgrade of any of those agents who versions are not currently in line with those defined (e.g., by an administrator). The upgrade manager 520 may prompt these upgrades by sending corresponding requests (e.g., 505) to the various host systems (e.g., 110) that are to host agents (e.g., 125), either directly to the agents themselves (e.g., if they are already active) or through corresponding service managers (e.g., 255) on the hosts. While such centralized agent upgrades may be specifically performed to upgrade agents in a centralized manner, providing opportunistic service manager upgrades to be performed with the agent upgrade may be advantageous as it reduces system downtime and removes user error corresponding to failures to update service manager parent processes (which may, in some cases, result in the service manager not being fully compatible with newly upgraded agents it is to manage), among other example advantages and issues.

In some implementations, the performance of a self-upgrade by an agent may include the agent accessing its corresponding upgrade file and loading, from the upgrade package, all needed upgrade resources for the upgrade. The agent may then replace its existing binaries with the new ones contained in the upgrade file. After the binaries have been replaced successfully, the agent shuts itself down and may provide a specific return code or other data to indicate that the upgrade is complete. In cases where multiple agents on a host are upgrading from the same upgrade package, each of the agents may perform similar steps and shut down upon completion of the binary replacement. The service manager on the host may detect the return code and then restarts the newly upgraded agent(s). In cases where the service manager is upgraded in connection with a centralized agent upgrade, the service manager may first complete its upgrade (which, in some cases, may also involve a restart of the service manager or even the host itself) before it attempts to restart the upgraded agent(s) based on this return code. With the upgraded agent(s) now restarted by the service manager, the upgraded agent(s) may each reconnect to the automation engine (e.g., through a respective one of the communication processes of the automation engine) with its new version.

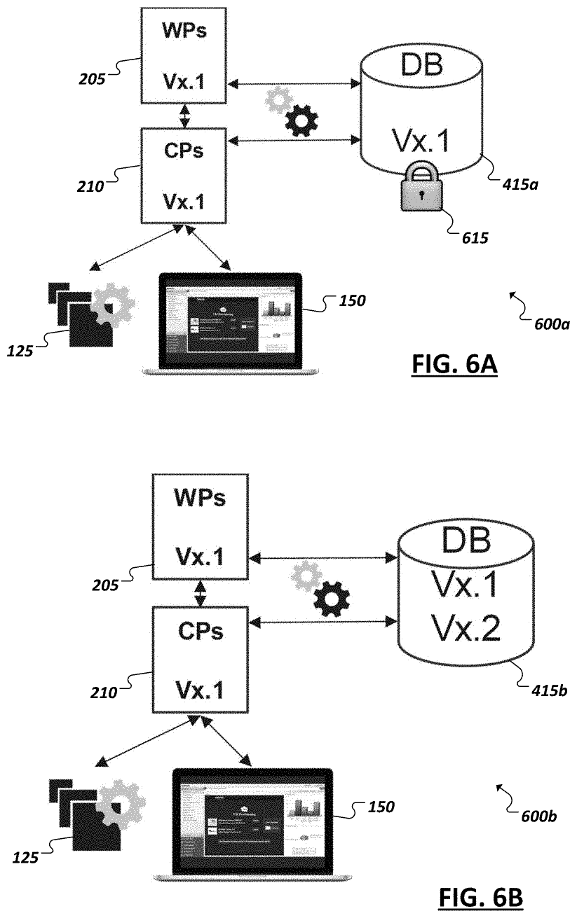

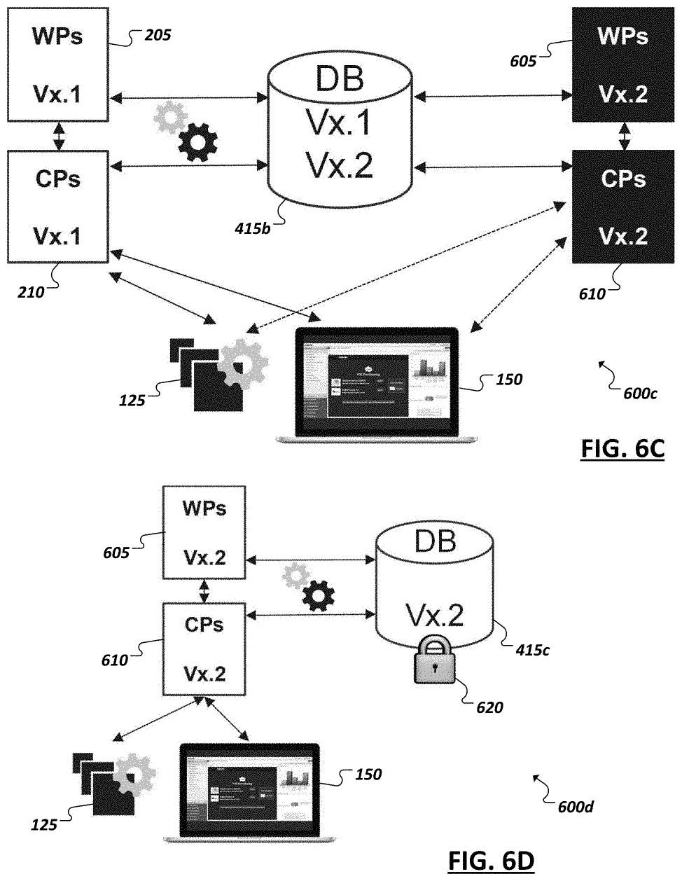

Other processes of an automation engine may also be upgraded, and such upgrades may be automated using computing processes and tools of the automation engine system. In some implementations, automation engine processes (e.g., communication processes and work processes) of an automation engine instance, may be updated with zero downtime in the operation of the system. For instance, turning to the examples of FIG. 6A-6D, simplified block diagrams 600a-d are shown illustrating an example of a zero-downtime upgrade of an automation engine system. As shown in FIG. 6A, an automation engine may be implemented through an automation engine database (e.g., 415a) in a first version (e.g., Vx.1) and corresponding work processes (e.g., 205) and communication processes (e.g., 210) that are of a corresponding version (e.g., Vx.1) of the automation engine. This version may be locked (e.g., as signified at 615), and the work processes 205 and communication processes 210 may be designed to be compatible with and utilize the corresponding version of the database.

When the automation engine is to be upgrade, the upgrade process may begin, as illustrated in FIG. 6B, with a hybrid version of the database (e.g., 415b) being prepared. The hybrid version of the database may be backward compatible with an earlier automation engine version's work processes (e.g., 205) and communication processes (e.g., 210), while including structures, tables, and columns that are to be used in a subsequent version of the automation engine. In some implementations, the hybrid, or mixed mode, version of the database 415b may be launched without bringing down the automation engine by utilizing a database upgrade utility to make these changes to the database (e.g., adding tables, columns, etc., renaming structures within the database and defining mappings between old and new names to enable the performance of translations of between these names, etc.) while the automation engine is running. When the database is upgraded to the mixed-mode version, a record may be developed that defines the changes made to the database and enables the possibility of later undoing these changes (i.e., while the upgrade to the new version is still “unlocked” or unfinalized). With the database upgraded, the automation engine processes (e.g., 205, 210) of the old automation engine version may continue utilizing (e.g., reading and writing data to) the database 415b, effectively unaware that they are interfacing with an upgraded version of the database 415 (given the backward compatibility maintained in the database 415b), as shown in FIG. 6B.

Turning to FIG. 6C, new versions of the automation engine processes (e.g., version Vx.2 work processes 605 and communication processes 610) may be launched following the upgrading of the database 415b and may be made available concurrently with the previous versions of the work processes 205 and communication processes 210 they are to replace. The existing work processes 205 and communication processes 210 may continue operating in connection with agents (e.g., 125) and user interfaces (e.g., 150) deployed in the automation engine system, to complete any tasks and related workflows, without interruption. However, as workflows are finished relating to specific work processes 205 and communication processes 210, opportunities may be identified to switch from the old version of a particular work process or communication process to the corresponding new versions of the same processes (e.g., 605, 610), which have already been launched and are awaiting work. Accordingly, the next workflows and tasks associated with these processes will be directed to the new versions of the processes (e.g., 605, 610), while the old versions are allowed to remain idle. Likewise, new connections may be established between any corresponding agents (e.g., 125) and UIs (e.g., 150) and the new versions of the communication processes (e.g., 610), as illustrated in FIG. 6C. These new versions of the work and communication processes (e.g., 605, 610) may utilize the same, (now) upgraded database, with old and new versions of the automation engine processes (e.g., 205, 210, 605, 610) simultaneously using the same upgraded (and backward compatible) automation engine database 415b in a mixed mode.

Continuing with the example of FIGS. 6A-6D, work may be gradually and opportunistically migrated from the old set of work processes 205 and communication processes 210 to the new versions of these work processes 605 and communication processes 610, until all work is being handled by the new versions of the work processes 605 and communication processes 610 (and using the upgraded database version 415b). In some implementations, both the old and new work process and communication process versions may be allowed to coexist, with the database in mixed mode, to provide an opportunity to test the stability, security, reliability, and functionality of the new version of the automation engine. If such testing reveals errors in any particular new version of an automation engine process, an upgrade manager may simply direct new jobs back to the old version of the corresponding processes, until any issues are resolved. Indeed, if the new version is found to include engine-wide failures, the entire upgrade may be immediately reversed by redirecting all new jobs back to the original versions of the work processes 205 and communication processes 210 (e.g., to abandon the current upgrade). However, when testing reveals that the new version of the automation is reliable, the upgrade may be finalized, or locked, and made permanent (e.g., through an administrator input), causing the old versions of the work processes 205 and communication processes 210 to be terminated and formally replaced by the new versions of the work processes 605 and communication processes 610. The database changes may also be finalized (at 620) to convert the database 415b from a mixed mode to the finalized new version 415c (e.g., Vx.2) and complete the upgrade of the entire automation engine system without incurring any downtime in the upgrade and transition from earlier versions of the automation engine database, work processes, and communication processes to new versions of the same.

In some implementations, a zero-downtime upgrade of an automation engine, its work processes, communication processes, and database, may result in the restarting and reconnection of various agents (e.g., 125) connected to and co-functioning with this automation engine. In some cases, such migrations from one version of a communication process to another may result in multiple concurrent restarts of corresponding agents in connection with the reconnection of these agents. In such cases, service manager mapping data may be utilized to identify which agents are children to which service managers, thereby directing the corresponding service managers to restart the proper agents on their corresponding host systems. Additionally, in some implementations, when agents are restarted in this manner, opportunities for agent upgrades may likewise be identified. Indeed, agent upgrade packages (which may include service manager upgrades) may be rolled out and offered in connection with an automation engine upgrade. For instance, an upgrade of the automation engine upgrade may include loading new upgrade packages into the automation database and an upgrade manager may send requests to service managers and/or agents to cause corresponding upgrades to be performed at the agents in connection with the automation engine upgrade. For instance, when agents are disconnected from a prior version of a communication process, a request to update the agents may be pushed to cause the agents to perform a self-upgrade before being restarted and connecting to the corresponding new versions of the communication process provided during a zero-downtime upgrade of the automation engine, among other example cases.

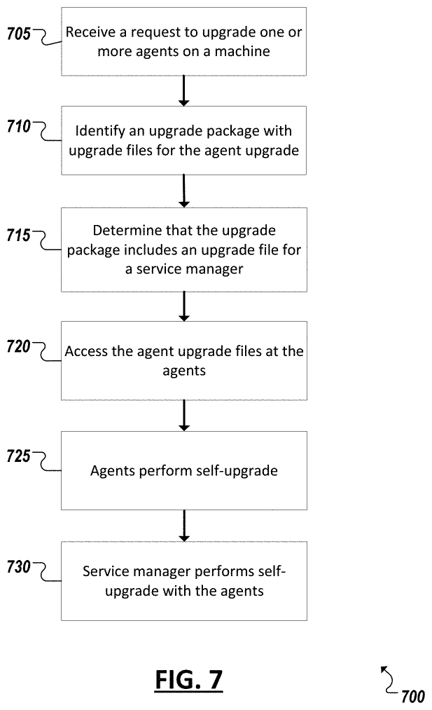

FIG. 7 is a simplified flowchart 700 illustrating an example technique for performing an opportunistic upgrade of an example service manager in connection with an upgrade of children agent processes of the service manager. For instance, a request to upgrade one or more agents on a host machine may be received 705, causing a corresponding upgrade package to be identified 710, which includes upgrade files for the agent upgrades. In connection with this request, it can be determined 715 whether the upgrade package also includes an upgrade file the service manager. If no service manager upgrade file is identified, the agent upgrade may proceed as normal, with the agents accessing 720 corresponding agent upgrade files to perform a self-upgrade 725. If a service manager upgrade is identified in the upgrade package, the service manager, in connection with the agent upgrades, may perform a corresponding self-upgrade 730 with the performance of the upgrade of the agents. In some cases, the service manager may complete its upgrade before the upgraded agents are restarted (by the service manager) to finalize the upgrades of the agents, among other example features and steps

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A method comprising:
receiving a request to upgrade one or more agents hosted on a particular computing system;
identifying an upgrade package stored in computer memory, wherein the upgrade package comprises a set of upgrade files;
determining that the upgrade package comprises a manager upgrade file for a service manager hosted on the particular computing system, wherein the one or more agents comprise child processes of the service manager;
accessing, using the one or more agents, corresponding agent upgrade files in the upgrade package;
autonomously performing upgrades at the one or more agents using the agent upgrade files; and
autonomously triggering performance of an upgrade of the service manager using the manager upgrade file based on the request to upgrade the one or more agents and presence of the manager upgrade file in the upgrade package, wherein the upgrade of the service manager is performed with the upgrades of the one or more agents.

2. The method of claim 1, wherein each of the one or more agents comprises an agent configured to run on a respective operating system of the particular computing system, and the agent enables actions to be performed using resources of the operating system in connection with a software automation task.

3. The method of claim 2, wherein the software automation task comprises one or more of a release automation task, a workload automation task, or a service orchestration task involving the particular computing system.

4. The method of claim 3, wherein the request is received from an automation engine system implemented at least in part on computing systems remote from the particular computing system, and the automation engine system orchestrates software automation tasks involving a set of agents on a set of computing systems, including the software automation tasks to be performed using the one or more agents on the particular computing system.

5. The method of claim 4, wherein the automation engine comprises a set of work processes and a set of communication processes, wherein the set of work processes trigger performance of the software automation tasks on the set of agents and monitor performance of the software automation tasks, and the set of communication processes facilitate communication between the work processes and the set of agents.

6. The method of claim 5, wherein the request and the agent update files are received through a particular one of the set of communication processes assigned to the one or more agents.

7. The method of claim 5, wherein the set of work processes comprises a particular work process hosted on the particular computing system, and the particular work process is a child process of the service manager.

8. The method of claim 4, wherein the automation engine system comprises a centralized database to support the software automation tasks and the update package is stored in and accessed from the database.

9. The method of claim 1, wherein the one or more agents comprise a plurality of agents and the plurality of agents perform respective self-upgrades substantially in parallel using the agent upgrade files.

10. The method of claim 1, wherein the one or more agents are launched and access to the one or more agents are managed using the service manager.

11. The method of claim 10, wherein the service manager is launched automatically in association with a reboot of the particular computing system.

12. The method of claim 11, wherein the service manager comprises a mapping data structure defining the one or more agents as managed by the service manager.

13. The method of claim 10, further comprising identifying an attempt by a communication process of an automation engine system to communicate with a particular one of the one or more agents, and autonomously activating the particular agent, using the service manager, based on identifying the attempt.

14. A non-transitory computer readable medium having program instructions stored therein, wherein the program instructions are executable by a computer system to perform operations comprising:
identifying an attempt to upgrade one or more agents hosted on a particular computing system, wherein the one or more agents are child processes of a service manager configured to manage processes of an automation engine on the particular computing system;
identifying an upgrade package for use in the upgrade of the one or more agents, wherein the upgrade package comprises a set of agent upgrade files for use by the agents to perform the upgrade of the one or more agents;
determining that the upgrade package further comprises an manager upgrade file for the service manager;
autonomously triggering performance of an upgrade of the service manager using the manager upgrade file based on the request to upgrade the one or more agents and presence of the manager upgrade file in the upgrade package, wherein the upgrade of the service manager is performed with the upgrades of the one or more agents.

15. A system comprising:
one or more data processing apparatus;
a memory;
an operating system;
a set of agents configured to perform automation actions using resources of the operating system, wherein the set of agents are to perform the automation actions at the direction of an automation engine; and
a service manager to:
identify an attempt to upgrade at least one of the set of agents;
identify an upgrade package for use in the upgrade of the at least one agent, wherein the upgrade package comprises a set of agent upgrade files for use by the at least one agent to perform the upgrade;
determine that the upgrade package further comprises a manager upgrade file for the service manager; and
perform an upgrade of the service manager using the manager upgrade file based on the attempt to upgrade the at least one agent and presence of the manager upgrade file in the upgrade package, wherein the upgrade of the service manager is to be performed with the upgrade of the at least one agent.

16. The system of claim 15, further comprising at least a portion of the automation engine.

17. The system of claim 16, wherein the automation engine comprises a database, a set of work processes to direct the automation tasks, and a set of communication processes to facilitate communication between the set of agents and the automation engine.

18. The system of claim 17, wherein at least a particular one of the work processes is hosted on a same host computer as the set of agents and the service manager.

19. The system of claim 18, wherein the particular work process and the set of agents are child processes of the service manager.

20. The system of claim 17, wherein the upgrade package is maintained in the database, and the upgrade package is accessed by the set of agents from the database.
